(19) United States
(12) Patent Application Publication
(10) Pub. No.: US 2013/0060485 A1
(43) Pub. Date: Mar. 7, 2013

(54) METHOD FOR AUTOMATICALLY OPERATING A MEASURING DEVICE FOR MEASURING PARTICLES IN GASES

(71) Applicants: Erich Unger, Graz (AT); Erich Schiefer, Selzthal (AT); Oliver Fritz, Graz (AT)

(72) Inventors: Erich Unger, Graz (AT); Erich Schiefer, Selzthal (AT); Oliver Fritz, Graz (AT)

(21) Appl. No.: 13/637,276

(22) PCT Filed: Mar. 15, 2011
(86) PCT No.: PCT/EP11/53890

§ 371 Date: Nov. 13, 2012

(30) Foreign Application Priority Data
Mar. 25, 2010 (AT) GM 199/2010

(51) Int. Cl. G01N 7/10; G06F 19/00

(52) U.S. Cl. 702/24

(57) ABSTRACT

In the course of a method for automatically operating a measuring device for measuring particles in gases, in particular for measuring carbon black particles in the exhaust gas of internal combustion engines, particle-related variables are repeatedly determined from the blackening of a filter paper in temporally limited individual measurements and the differential pressure caused by the flow of measurement gas is monitored via the internal measuring diaphragm, wherein the individual measurement is automatically terminated and an error message is output below a primary threshold value for the differential pressure. In order to now minimize interruptions in measurement operation and to increasingly ensure that correct measured values are output, the passing of a secondary threshold value for the differential pressure, which is above the primary threshold value, is monitored and the individual measurement is automatically terminated if this secondary threshold value is undershot, and the satisfaction of at least one predefined criterion is checked, wherein the individual measurement is terminated with an error message if this criterion is not satisfied, whereas a measured value is output if the criterion is satisfied.

The invention relates to a method for automatically operating a measuring device for measuring particles in gases, in particular for measuring carbon black particles in the exhaust gas of internal combustion engines, with which particle-related variables are repeatedly determined from the blackening of a filter paper in temporally limited individual measurements, and the differential pressure caused by the flow of measurement gas is monitored via the internal measuring diaphragm, wherein the individual measurement is automatically terminated and an error message is output below a primary threshold value for the differential pressure. For measuring carbon black particles, mainly but not exclusively, of internal combustion engines, measuring devices in which a gas containing the particles is fed for a certain time over a filter paper have been very successfully used for a long time. The particles are filtered out on the filter paper and finally, the blackening of the paper with carbon black particles is measured. However, during fully automated measurements, which can be performed without monitoring by personnel, many different causes can lead to critical conditions during the tests which can result in an error message and/or termination of a measurement. In fully automated test stands which vary the test modes according to statistical “evolutionary algorithms” or measure fixed predefined parameter fields it is also possible, however, that test settings occur again and again in which too many particles are deposited during a measurement. This can result in a considerable pressure drop or the flow rate can be reduced too much so that a pressure error or flow rate error message occurs. However, such error messages or warnings can also occur or, respectively, the likelihood for these error messages increases if the flow rate has already been additionally reduced due to insufficient maintenance or due to unexpected additional system contamination caused by the measurements themselves. The same effects also occur if significant negative pressures occur within the system during the measurement, or the flow rates are reduced due to pressure resonances, or if the measuring probe or a measurement gas tube is excessively contaminated or even “plugged”. Of course, such errors can also occur if hardware, for example, the pump or also a solenoid, is no longer perfectly functioning but otherwise is only latently defective.

Since incorrect or incomplete measuring cycles very often require a new measuring run or in some cases can even result in a complete termination of the test runs, such interruptions are undesirable and expensive. On the other hand, an error message or deactivating the measuring device is required upon exceeding a critical parameter which indicates dangerous conditions in general or for the measuring device, or if correct measurements can no longer be ensured because an exceedance of such a parameterized threshold/limit occurs.

In order to now minimize interruptions in measurement operation and to increasingly ensure that correct measured values are output, it is provided according to the invention that the passing of a secondary threshold value for the differential pressure, which is above the primary threshold value for the differential pressure, is monitored and the individual measurement is automatically terminated if this secondary threshold value is undershot, and the satisfaction of at least one predefined criterion is checked, wherein the individual measurement is terminated with an error message if this criterion is not satisfied, whereas a measured value is output if the criterion is satisfied. It was surprisingly found that very often sufficient information and data and measured values are available in a multiplicity of basic conditions which cause error messages, and that by intelligently evaluating them, a correct measured value can still be output even in the case of termination of the measurement due to the occurrence of a critical condition, and therefore it is no longer required to terminate the complete test. Such an evaluation can be carried out in that a second threshold has been introduced at which the evaluation of the data is carried out. Under these conditions, an error is only output if insufficient data for correct calculation and/or evaluation is available, or if the primary threshold value is exceeded within a very short time or the exceedance of the primary threshold value is so significant that this would result in danger for or in damage to the device or the test stand.

According to an advantageous embodiment variant, the secondary threshold value for the differential pressure lies between 20 and 50% above the primary threshold value. Advantageously, in a further variant of the invention, an actual threshold value is predetermined by multiplying a basic threshold value by the ratio of the actual pressure to a reference pressure, and in addition to the primary and the secondary threshold values, an unchangeable third minimum threshold value is predetermined and upon undershooting of the same, the individual measurement is terminated in any case with an error message.

Preferably, it is provided here that for a reference pressure of 100 kPa, preferably at a reference temperature of 25° C., the minimum threshold value is predetermined between 1.5 and 3 kPa, the secondary threshold value with approx. 5.5 kPa, and the primary threshold with approx. 4 kPa.

According to another exemplary embodiment of the invention it is provided that the amount of measurement gas sucked in through the filter is checked as a criterion.

Preferably, in this case, an error message is always output at an amount of 100 ml, satisfaction of at least one further criterion is checked at an amount between 100 ml and 500 ml, and a measured value is output in any case at an amount greater than 500 ml.

According to a further optional feature of the invention it is provided that the presence of an internal drift evaluation of the measurement signals is checked as a criterion.

An advantageous embodiment of the invention provides that in the case of an inactive drift evaluation, only the primary threshold value is considered as a criterion and that an error is always output if this threshold is undershot, but a measured value is always output at or above this threshold value.

An advantageous variant of the method according to the invention further provides that it is checked whether or not the internal drift evaluation of the measurement signals is activated, and that in the case of an inactive drift evaluation and an amount of measurement gas of less than 500 ml, an error message is output, and that when satisfying at least one criterion, the paper blackening is used in addition as a criterion.

Furthermore, a minimum blackening of the filter paper can also be checked as a criterion.

Preferably, a measured value is output at a blackening of at least 0.2, and an error message is output at a blackening of less than 0.2.

In the following description, the invention shall be explained in more detail by means of a concrete example in which in particular an evaluation of the flow rate of the measurement gas or of the differential pressure and the negative pressure takes place, and by means of the enclosed figures.

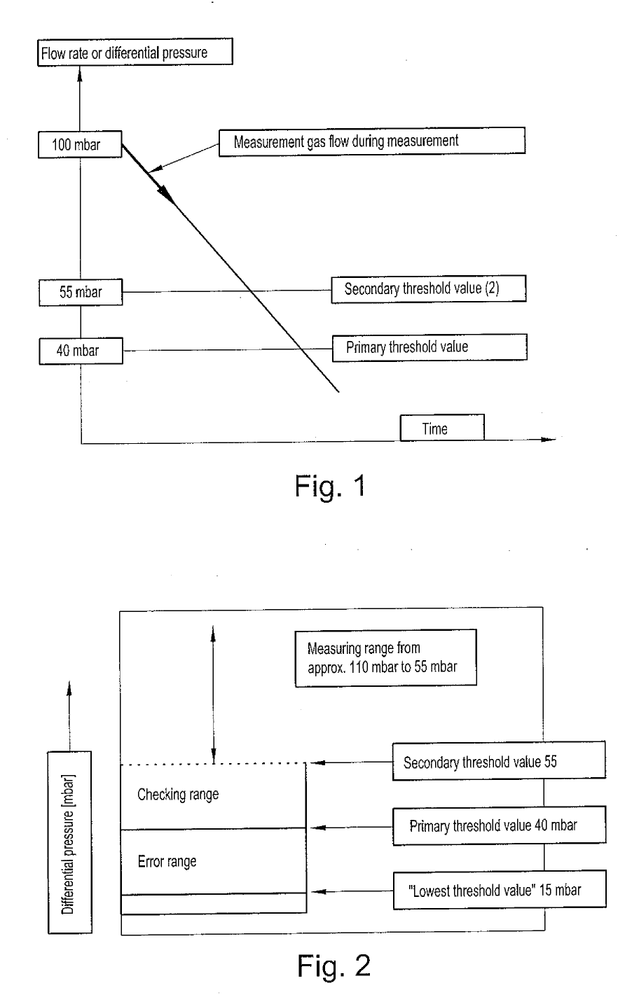

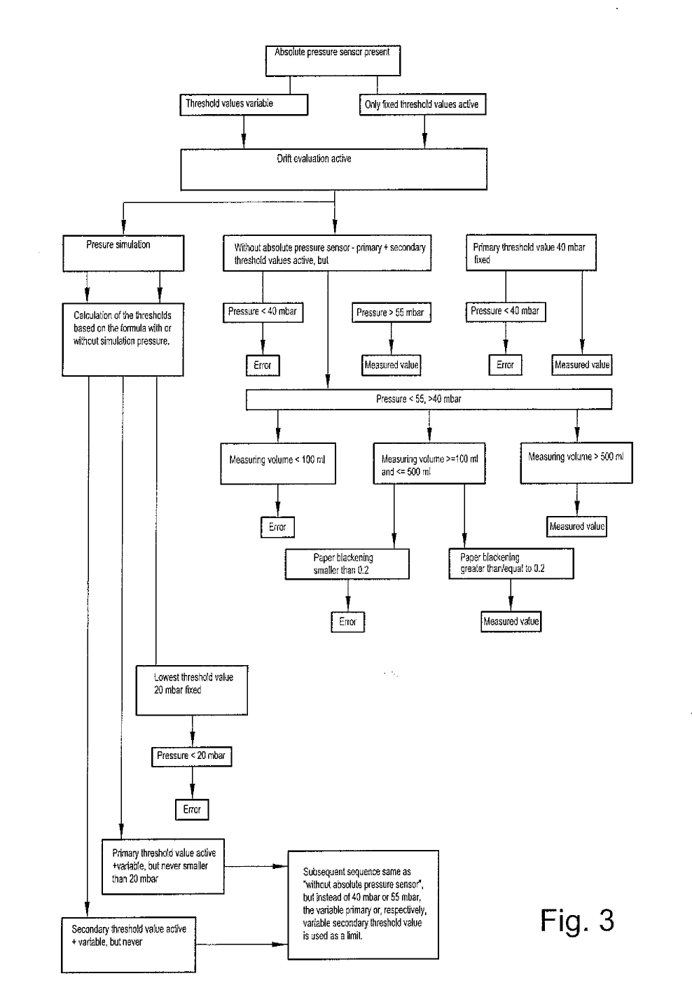

FIG. 1 shows a diagram of a simplified, basic measuring sequence and of the differential pressure values and flow rate values occurring in the course of this sequence, FIG. 2 shows, for a typical functional sequence, the definition of the threshold values for the negative pressure generated at a section of measuring diaphragms by the measurement gas flow itself and its throttling, and the threshold values or triggering limit values for the termination of the measurement and/or for the output of an error message when undershooting the error limit, and FIG. 3 is a flow diagram of a typical functional sequence according to the present invention.

A measurement gas containing particles flows in the measuring device for a certain time over a filter paper. In the course of this, particles are filtered out at the filter paper and finally, the blackening of the paper with carbon black particles is measured. Usually, the measurement gas flow rate is determined through the differential pressure drop across a measuring diaphragm and the relative pressure at the measuring site; however, it can also be measured directly. As another alternative it is also possible to perform an evaluation by means of the duration of the gas flow as a parameter, wherein, for example, at a nominal gas flow of 10 liter per minute, said duration corresponds to a measurement gas flow duration of 6 sec.

If too many particles are deposited thereby causing a high pressure drop or a greatly reduced flow rate, a pressure error or flow rate error message is generated. Such error messages or warnings can also occur in a different connection, for example, due to insufficient maintenance, due to unexpected additional system contamination, if strong negative pressures occur in the system during the measurement, if the flow rates are reduced due to pressure resonances, or if the measuring probe or a measurement gas tube has been excessively contaminated or is even “plugged”. Such errors can also occur in the case of hardware problems, for example, if the pump or also a solenoid valve is no longer perfectly functioning but otherwise is only latently defective.

However, since in a multiplicity of basic conditions sufficient information and data and measured values are still available, which, when evaluated intelligently, can result in a correct measured value, the passing of a secondary threshold value for the differential pressure, which is above the primary threshold value, is monitored in addition the primary threshold value—as illustrated in FIG. 1 by means of a simple example—and the individual measurement is automatically terminated if this secondary threshold value is undershot. Usually, the secondary threshold value is set approx. 20 to 50% above the primary threshold. These threshold values are indicated as differential pressures. The gas flow generates differential pressures at a measuring diaphragm fitted in the measuring device, wherein these differential pressures are higher the higher or greater the flow rates are. In terms of nomenclature, greater or higher values are “above” the smaller or “lower” values.

During a typical measurement at an ambient pressure of 100 kPascal and 25° C., and with a correctly functioning measuring system without significant contaminations, and with a still clean filter paper that is “not loaded” with particles, the measurement gas flow creates a differential pressure of approx. 100 mbar at the flow measuring diaphragm. During the measurement, the measurement filter is loaded with particles and the flow resistance increases so that the flow through the measuring diaphragm can drop more or less slowly and because of this, the differential pressure across the measuring diaphragm also drops during the measurement. An error is always output if the differential pressure value of 40 mbar at the primary threshold value (1) is undershot. This value is identical to the error limit. “During measuring”, the secondary threshold value (2) of, e.g., 55 mbar is active and upon undershooting the same, the measurement is terminated and an evaluation of the data is performed. Depending on the data situation, a measured value or an error message is output.

FIG. 2 illustrates an advantageous expanded definition of the threshold values for the negative pressure generated at a section of measuring diaphragms by the measurement gas flow itself and its throttling, and the threshold values or triggering limit values for the termination of the measurement and/or for the output of an error message when undershooting the error limit.

The error range is the range in which an error is always output; either because due to a quick event, the measured value of the differential pressure relevant for the flow rate has fallen below this value or because the differential pressure caused by the flow rate has not exceeded this value right from the beginning. The checking range between, for example, the defined values of 40 and 55 mbar is the range in which it is checked in terms of the available measurement data if enough measurement data and enough significant measurement data are available for enabling a correct calculation of measured values from this available data.

If the primary and the secondary threshold values are variable by including the absolute pressure and/or a simulation pressure for height simulations in the calculation of these threshold values, then, the checking range and the error range are also variable. However, advantageously, it is also possible to define a “lowest threshold value” at which an error is always output if said value is undershot, thus, a value which can never be undershot without causing an error message. The illustrated “third threshold” or “lowest threshold” replaces the “primary threshold” if the primary and the secondary threshold values are defined to be variable. For the use of variable threshold values, the absolute ambient pressure has to be measured or read in or parameterized by a sensor. Likewise, a potential “simulation pressure value” has to be read in or “reported” to the measuring device.

If during the measurement or already at the start of the measurement, the primary threshold value (1) or the “lowest threshold value” according to FIG. 2 is undershot by the measured differential pressure, e.g., because the pump is defective or because an existing safety filter is completely “plugged”, in this case too, an error message is always output.

A typical functional sequence is exemplary described in the flow diagram of FIG. 3, wherein detailed sequences can also be performed in a different order and/or can be provided with additional functional sub-sequences. The illustrated sequence assumes that a measurement was started and all other parameterizations for a correct execution of a measurement were carried out correctly. Additional and further parallel monitoring and checks are not illustrated here. Illustrated in the sequences are only such sequences which are required for the automatic “intelligent” data evaluation set forth in this patent or are required for directly or indirectly involved checks of parameters. The pressure indicated in the flow diagram is always the differential pressure of the flow measurement values or the threshold values.

The check for satisfaction of at least one predefined criterion takes place automatically, except in the case of undershooting the lowest threshold values, wherein the individual measurement is terminated with an error message if this criterion is not satisfied. If, however, the predefined criterion is satisfied, a measured value is output. An error is only output if insufficient data for correct calculation and/or evaluation is available, or if the primary threshold value is exceeded within a very short time or the exceedance of the primary threshold value is so significant that this would result in danger for or in damage to the device or the test stand.

The automatic check can be configured such that, for example, it is checked if the way of measuring in fact allows evaluating the data available at the time of termination of the measurement. For example, such an evaluation is not carried out if the white level check is deactivated—alternatively, separate or additional evaluation of the black level drifts or of temperature measurement drifts would also be possible as further additional or alternative criteria— . . . Alternatively, it can be checked if the flow rate has reached an upper threshold, which in most cases or generally allows an evaluation of the measurement data, or if the paper blackening at the time of termination has exceeded a given threshold value, and if in the course of this, the flow rate (the sucked in measurement gas volume or, alternatively, the measurement period) has reached a minimum value. If this measurement data allows a correct evaluation of the filter blackening number (FBN), a measured value is output, and if not, an error message is output.

The concrete implementation finally takes place according to an exemplary embodiment of the invention as follows:

During measurement, the secondary threshold value of, e.g., 55 mbar is active, and if said value is undershot, the measurement is terminated and an evaluation of the data takes place. Depending on the current data, a measured value or an error message is output. If the primary threshold of 40 mbar is undershot during the measurement or already at the beginning of the measurement, likewise, an error message is always output.

If internal drift evaluation—in particular, white level monitoring of the measuring system—of the measuring device is deactivated or if due to other measures an increased drift is to be expected (but still is within the device specification), an error message (flow error or differential pressure error) is always output during the parameterized measuring sequence if a gas flow occurs that is too low. Under these circumstances, an incorrect evaluation of the data might be possible during the presence of a real measurement drift.

Otherwise, the measuring sequence is prematurely terminated if the gas flow through the measuring system is too low. This takes place in particular if the differential pressure across the measuring diaphragm falls below the threshold value of 55 mbar. The parameter limit for the flow rate error is right at 40 mbar; thus, the threshold value is approx. 35% above the parameter for the error limit. Alternatively, in the present case, the gas flow can also be measured directly, e.g., with a mass flow meter, or as another alternative, it is also possible to check the duration of the gas flow as a parameter. After termination of the measurement, it is checked if a given minimum amount of gas is sucked through the filter, wherein the minimum amount of gas is preferably a value of 500 ml (or, alternatively, a period of approx. 3 sec). In this case, an evaluation of the data is always carried because a measurement gas flow of 500 ml is usually always sufficient to ensure data evaluation within the device specification.

If a gas flow of more than 100 ml but less than 500 ml was present at the time of termination of the measurement, a measurement data evaluation is carried out and a measured value is output if the paper blackening is greater than or equal to 0.2. At such a paper blackening and with a drift evaluation being available, the specified measuring accuracy of the measuring device can still be met correctly. If the paper blackening is smaller than 0.2, an error message is output.

If the measurement gas flow is less than 100 ml (or . . . , the measurement period is approx. 0.5 sec.) at the time of termination of the measuring sequence, a flow rate error is always output because a correct evaluation of the measurement data cannot be ensured under these circumstances. Likewise, when undershooting the differential pressure of 40 mbar, i.e. the primary threshold value, an error is always output. This value is identical to the error limit.

The primary and secondary threshold values can advantageously be expressed as functions of the ambient pressure at the measuring system, namely such that these two pressure thresholds of 40 mbar and 55 mbar (or more general, the primary and secondary pressure thresholds) refer to a measurement gas flow at a reference pressure of 100 kPascal and at a reference temperature of preferably 25° C. (298 Kelvin).

Alternatively, these differential pressure values, which due to the measurement gas flow result from the pressure drop at a dynamic pressure orifice, can also refer to a different reference temperature, for example, to 15° C. Likewise, if needed, it is of course also possible to use different pressures as reference pressures. The values to be used in this case as reference pressures and reference temperatures shall always be in the range of 30 to 200 kPascal, but preferably in the pressure range of 50 to 110 kPascal and the temperature range of 230 to 400 Kelvin, preferably 270 to 370 Kelvin.

Furthermore, if external pressure and flow rate settings are to be simulated for specific measuring sequences, for example, for height simulation tests, and because of this, the limit values/threshold values have to be or are to be additionally adjusted, this can then also be included in the calculation formalism.

This kind of function is exemplary illustrated with the following simple formalism:

Threshold value X=threshold value (e.g. 55 mbar, at 100 kPascal)*[Psim/Pa]*(Pa/Pref), wherein Psim is the simulation pressure, e.g., in a pressure simulator. If no simulation pressure is present or no simulation pressure has been parameterized or is read in, then the square parenthesis [Psim=Pa] applies, with Pa being the absolute ambient pressure. The reference temperature is fixed with 25° C. (298 Kelvin) in the above formula and therefore is invisibly included (or is indirectly included as factor Tref/Tref). Pref is the reference pressure (100 kPascal, for example). The ambient pressure and/or the simulation pressure are entered as values or entered in analogue or digital form, or are parameterized. Preferably, the ambient pressure is measured at or in the device by means of an absolute pressure sensor.

If a reference temperature different than 25° C. is to be used, this is to be included in the above formula as follows:

Threshold value X1=threshold value X*(Tref/Trefnew) with Tref=298 Kelvin, (25° C.), with Trefnew being the alternative/new reference temperature in Kelvin.

In order to ensure the principle measuring accuracy for the filtering method used, it is required that the surface flow velocity on the filter paper surface in the measuring device stays within a given range. At typical ambient pressures of 50 to 110 kPascal, this is possible with defined “fixed thresholds”; however, at an ambient pressure of 50 kPascal, the measured value is already close to the threshold value of 55 mbar from the beginning. However, since on the other hand, the membrane pump used delivers a “constant volume”—independent of the ambient pressure—the threshold values can be adjusted when the device measures the ambient pressure and the differential pressure and the relative pressure at the filter paper relative to the ambient atmosphere, or when this data of the ambient pressure is reported to the measuring device.

A similar method can also be used if sampling in height and pressure simulation tests is used in systems which operate in a negative pressure level, but the measuring device itself operates at normal ambient pressure. For this, the simulation pressure can be reported to the measuring device or can be entered in the device. In this case it is additionally required—or is at least recommended—that the exhaust gas is fed back again close to the sampling point.

However, in order to avoid incorrect or inaccurate measured values when including variable thresholds as in the above formalisms, it is required for the error check to introduce a further “lowest limit value/threshold value” or limit value for flow rate monitoring which, independent of all types of parameterization, outputs an error message if this “lowest threshold value” is undershot. In the present case, this “third threshold value” preferably lies in the range of 15 to 20 mbar. This potential increase of measuring inaccuracy at low absolute pressures is caused due to the fact that the sensors used for the pressure measurements usually have a limited resolution of measured values, and with decreasing measured values, the resulting possible effects of errors become more significant. Otherwise, measured value deviations greater than the maximum inaccuracy of the measured values guaranteed in the specification of the measuring device would have to be expected as soon as the defined “lowest threshold value” is undershot.

It has principally to be mentioned that potentially all these sequences for measuring a gas flow value and checking and monitoring the same by means of limit values can of course be carried out in a similar manner by measuring and monitoring other measurands, for example, by measuring a heat-sink flow—similar to a hot wire flow meter—or by means of a direct flow measurement by means of a mass flow meter etc.

1. A method for automatically operating a measuring device for measuring particles in gases, in particular for measuring carbon black particles in the exhaust gas of internal combustion engines, with which particle-related variables are repeatedly determined from the blackening of a filter paper in temporally limited individual measurements, and the differential pressure caused by the flow of measurement gas is monitored via the internal measuring diaphragm, wherein the individual measurement is automatically terminated and an error message is output below a primary threshold value for the differential pressure, wherein the passing of a secondary threshold value for the differential pressure, which is above the primary threshold value, is monitored and the individual measurement is automatically terminated if this secondary threshold value is undershot, and the satisfaction of at least one predefined criterion is checked, wherein the individual measurement is terminated with an error message if this criterion is not satisfied, whereas a measured value is output if the criterion is satisfied.

2. The method according to claim 1, wherein the secondary threshold value for the differential pressure lies between 20 and 50% above the primary threshold value.

3. The method according to claim 1, wherein an actual threshold value is predetermined by multiplying a basic threshold value by the ratio of the actual pressure to a reference pressure, and that in addition to the primary and secondary threshold values, an unchangeable third minimum threshold value is predetermined and upon undershooting of the same, the individual measurement is terminated in any case with an error message.

4. The method according to claim 1, wherein a reference pressure of 100 kPa, preferably at a reference temperature of 25° C., the minimum threshold value is predetermined between 1.5 and 2 kPa, the secondary threshold value with approx. 5.5 kPa, and the primary threshold with approx. 4 kPa.

5. The method according to claim 1, wherein the amount of measurement gas sucked in through the filter is checked as a criterion.

6. The method according to claim 5, wherein an error message is always output at an amount of 100 ml, satisfaction with at least one further criterion is checked at an amount between 100 ml and 500 ml, and a measured value is output in any case at an amount greater than 500 ml.

7. The method according to claim 1, wherein the presence of an internal drift evaluation of the measurement signals is checked as a criterion.

8. The method according to claim 7, wherein the case of an inactive drift evaluation, only the primary threshold value is considered as a criterion and that an error is always output if this threshold is undershot, but a measured value is always output at or above this threshold value.

9. The method according to claim 1, wherein in the case of an inactive drift evaluation and an amount of measurement gas of less than 500 ml, an error message is output, and that when satisfying at least one criterion, in addition, the paper blackening is also used as a criterion.

10. The method according to claim 1, wherein a minimum blackening of the filter paper is checked as a criterion.

11. The method according to claim 10, wherein a measured value is output at a blackening of at least 0.2, and an error message is output at a blackening of less than 0.2.
